(19) United States
(12) Patent Application Publication
(10) Pub. No.: US 2009/0223034 A1
(43) Pub. Date: Sep. 10, 2009

(54) METHOD OF PRODUCING THIN FILM MAGNETIC HEAD

(75) Inventor: Hironori Saito, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/207,311

(22) Filed: Sep. 9, 2008

(30) Foreign Application Priority Data
Mar. 7, 2008 (JP) 2008-057178

(51) Int. Cl. G11B 5/127

(52) U.S. Cl. 29/603.09

(57) ABSTRACT

The method of producing a thin film magnetic head from a raw bar, in which a plurality of combinations of a thin film magnetic head including a reproducing head and an ELG element are continuously formed, comprises the steps of: measuring resistance of a magnetoresistance effect element section of each ELG element as first resistance; measuring resistance of a magnetoresistance effect element section of each thin film magnetic head as second resistance; detecting existence or nonexistence of a smear in an air bearing surface of each thin film magnetic head on the basis of the difference between the first resistance and the second resistance; and removing the smear from only the thin film magnetic head in which the existence of the smear is detected.

### BACKGROUND OF THE INVENTION

The present invention relates to a method of producing a thin film magnetic head, more precisely relates to a method of producing a thin film magnetic head which includes a reproducing head having a magnetoresistance effect element.

These days, memory capacities of storing units, e.g., magnetic disk unit, have been significantly increased. Thus, improving performance of storage media and improving reproduction characteristics of magnetic heads are required.

Reproducing heads including magnetoresistance effect elements, e.g., giant magnetoresistance (GMR) element capable of obtaining a high output power, tunneling magnetoresistance (TMR) element capable of obtaining high reproduction sensitivity, have been developed. On the other hand, induction type recording heads using electromagnetic induction have been developed. For example, a composite type thin film magnetic head, in which the above described reproducing head and recording head are combined, is now used.

Generally, a thin film magnetic head is constituted by a substrate composed of a ceramic, e.g., ALTIC (Al₂O₃—TiC), a protection and insulation film composed of a ceramic, e.g., alumina (Al₂O₃), a magnetic metal film composed of a composite material, e.g., permalloy (Fe—Ni), sendust (Fe—Al—Si), etc . . . . . An air bearing surface of the thin film magnetic head is formed by abrading with free grain slurry. The ceramics, e.g., ALTIC, alumina, are hard materials; the magnetic metals e.g., permalloy (Fe—Ni), sendust (Fe—Al—Si), are soft materials. Therefore, the soft materials are selectively abraded due to difference of hardness, and thereby pole tip recession (PTR), in which the metal films constituting magnetic pole parts, etc. are recessed from the air bearing surface composed of the ceramic, are formed. By forming the PTR, a clearance between a storage medium and the magnetic head is increased, so a problem of substantially increasing an amount of floating the magnetic head is caused. To solve the problem, a method of solving the selective abrasion and the abrasion difference have been studied.

On the other hand, in case of abrading the thin film magnetic head with the free grain slurry, surfaces of the soft materials are selectively abraded due to difference of hardness, the abraded surfaces are roughened, and scratches are formed in the abraded surfaces. Especially, if a scratch traversing the abraded surface will cause short circuit and will worsen magnetic characteristics of the thin film magnetic head. These days, metal films of the magnetic pole parts and insulation films are made thinner and thinner with improving magnetic characteristics of magnetic heads, so short circuit will be easily caused by scratches.

Especially, in case of using a magnetoresistance effect element having a CPP (current perpendicular to the plane) structure, e.g., TMR element, in a reproducing head, if an air bearing surface is mechanically abraded by a conventional method, fine dusts formed by abrading a ferromagnetic layer, etc. (hereinafter referred to as “smear”) will stick on side faces of a tunnel barrier layer, and the tunnel barrier layer will be electrically shorted. Therefore, a problem of worsening characteristics of the element will be easily caused.

However, mechanically abrading the air bearing surface is important for defining a vertical length of the element with respect to the air bearing surface (hereinafter referred to as “element height”), so the abrading step cannot be omitted. Conventionally, smears formed by the mechanical abrading process are removed, by dry etching or ion milling, after mechanically abrading the air bearing surface (see Japanese Laid-open Patent Publication No. 11-175927).

Generally, after the mechanical abrading step, smears are removed from a raw bar, in which a plurality of thin film magnetic heads are included, before cutting the raw bar to form independent thin film magnetic heads. In case of removing smears by ion milling, an amount of abrading the air bearing surface must be the greatest necessary amount for removing smears from the entire raw bar. Therefore, all of the thin film magnetic heads in the raw bar are simultaneously ion-milled in a vacuum container, so the PTRs must be deeper.

On the other hand, in case of removing smears by a buffing pad, particles formed by the buffing work will stick on the air bearing surface, from which smears have been removed, as new smears so it is difficult to perfectly remove smears.

### SUMMARY OF THE INVENTION

The present invention was conceived to solve the above described problems.

An object of the present invention is to provide a suitable method of producing a thin film magnetic head, which is capable of detecting a smeared thin film magnetic head in a raw bar mechanically abraded, removing the smear from only the smeared thin film magnetic head and solving the problem of deepening the PTRs.

To achieve the object, the present invention has following constitutions.

Namely, the method of producing a thin film magnetic head from a raw bar, in which a plurality of combinations of a thin film magnetic head including a reproducing head and an ELG element are continuously formed, comprises the steps of: measuring resistance of a magnetoresistance effect element section of each ELG element as first resistance; measuring resistance of a magnetoresistance effect element section of each thin film magnetic head as second resistance; detecting existence or nonexistence of a smear in an air bearing surface of each thin film magnetic head on the basis of the difference between the first resistance and the second resistance; and removing the smear from only the thin film magnetic head in which the existence of the smear is detected.

In the method, the removing step may be performed by abrading only the thin film magnetic head, in which the existence of the smear is detected, with an abrasion pad.

In the method, the removing step may be performed by etching only the thin film magnetic head, in which the existence of the smear is detected, with ion beams.

In the method, the removing step may be performed by wet-etching only the thin film magnetic head, in which the existence of the smear is detected.

The method may further comprise the step of etching the entire surface of the raw bar, which includes the air bearing surfaces of the thin film magnetic heads, with ion beams after performing the removing step.

In the method of the present invention, the smeared thin film magnetic head in the raw bar, which has been mechanically abraded, can be detected. The smear can be removed from only the smeared thin film magnetic head.

### BRIEF DESCRIPTION OF THE DRAWINGS

Embodiments of the present invention will now be described by way of examples and with reference to the accompanying drawings, in which:

FIG. 1 is a schematic view of a raw bar including thin film magnetic heads, which relates to embodiments of the method of the present invention;

FIG. 2 is a sectional view of an ELG element taken along a line A-A′ shown in FIG. 1;

FIG. 3 is a sectional view of the ELG element taken along a line a-a′ shown in FIG. 1;

FIG. 4 is a graph, in which differences between element heights MR-h, which are converted from resistance MR-R of a magnetoresistance effect element section of the thin film magnetic head, and element heights ELG-h, which are converted from resistance ELG-R of a magnetoresistance effect element section of an ELG element, are plotted;

FIG. 5 is a graph, in which the differences between the element heights MR-h of the thin film magnetic heads and the element heights ELG-h of the ELG elements corresponding to positions in the raw bar are plotted;

FIG. 6 is an explanation view showing the step of removing smears in a first example of a step of removing a smear;

FIG. 7 is an explanation view showing the step of removing smears in a second example of the step of removing a smear;

FIG. 8 is an explanation view showing the step of removing smears in a third example of the step of removing a smear; and

FIG. 9 is a schematic view of another raw bar including thin film magnetic heads.

FIG. 10 is a schematic view of a TMR element.

### DETAILED DESCRIPTION OF THE EMBODIMENTS

Preferred embodiments of the present invention will now be described in detail with reference to the accompanying drawings.

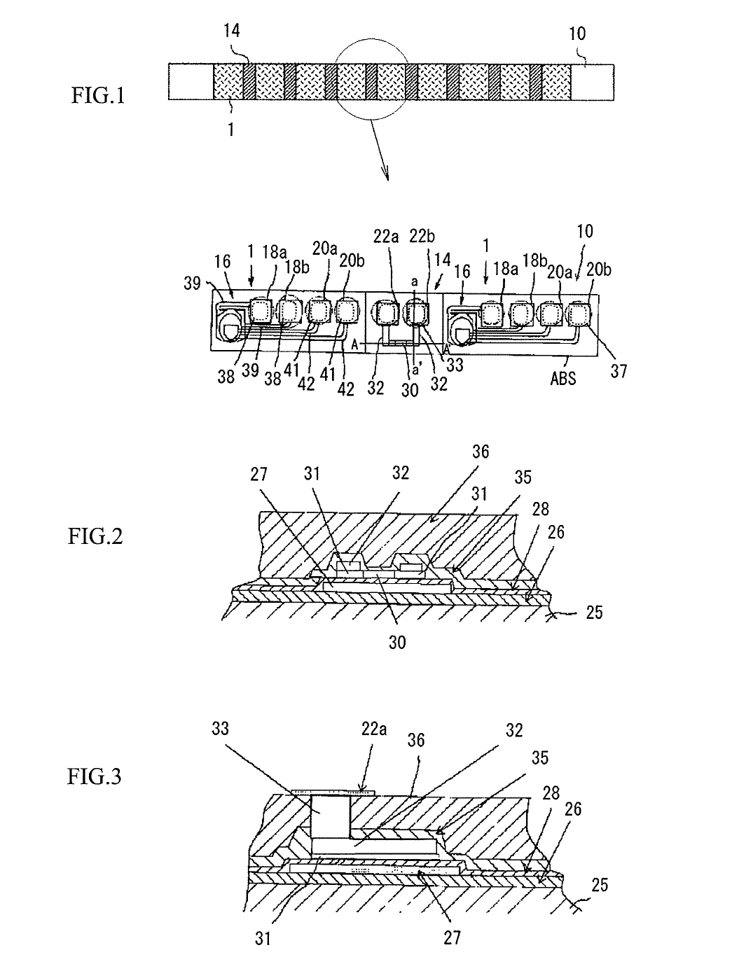

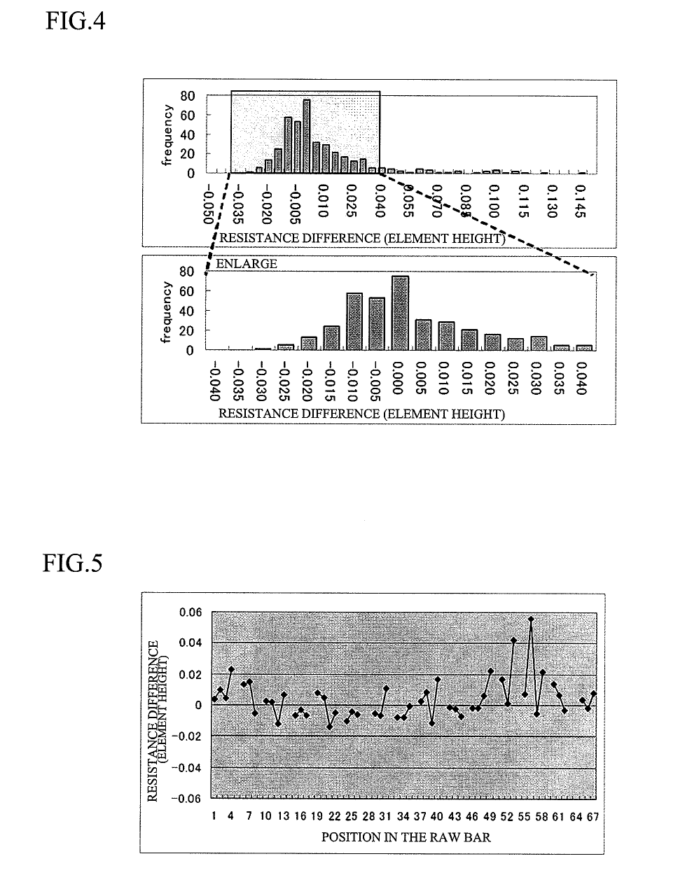

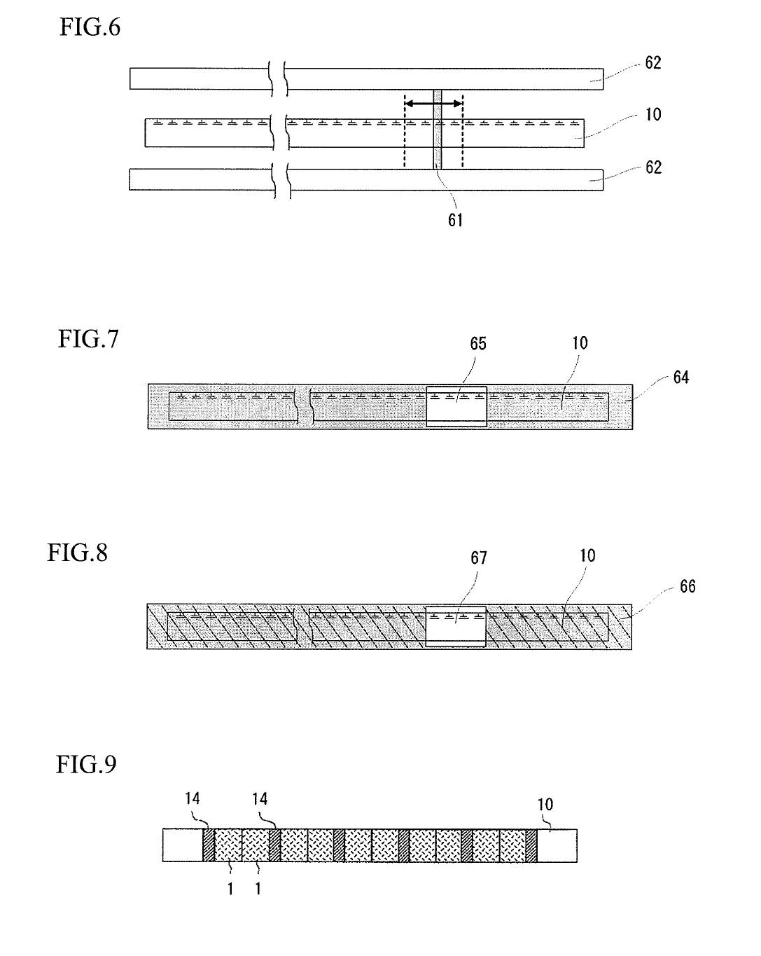

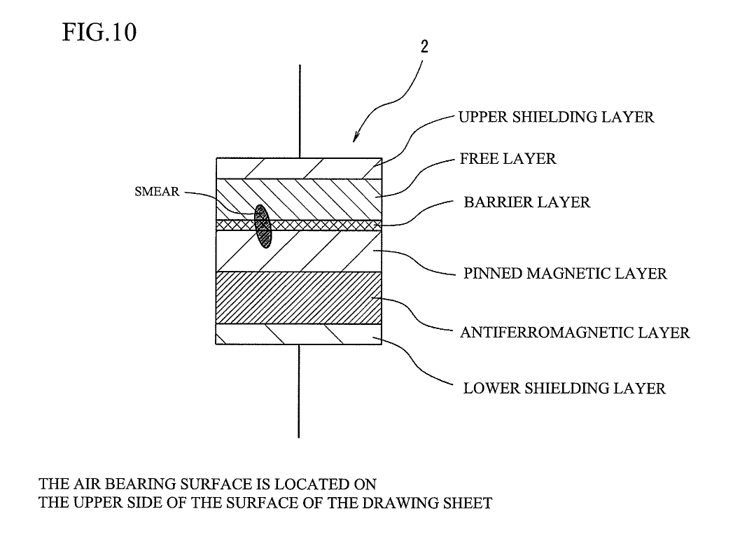

FIG. 1 is a schematic view of a raw bar 10 including thin film magnetic heads 1, which relates to the embodiments of the method of the present invention; FIG. 2 is a sectional view of an ELG element 14 taken along a line A-A′; FIG. 3 is a sectional view of the ELG element 14 taken along a line a-a′; FIG. 4 is a graph, in which differences between element heights MR-h, which are converted from resistance MR-R of a magnetoresistance effect element section of the thin film magnetic head 1, and element heights ELG-h, which are converted from resistance ELG-R of a magnetoresistance effect element section 30 of an ELG element 14, are plotted; FIG. 5 is a graph, in which the differences between the element heights MR-h of the thin film magnetic heads 1 and the element heights ELG-h of the ELG elements 14 corresponding to positions in the raw bar 10 are plotted; FIGS. 6-8 explanation views showing the step of removing smears in the embodiments of the method of the present invention; FIG. 9 is a schematic view of another raw bar 10 including thin film magnetic heads 1; and FIG. 10 is a schematic view of TMR element 2.

In the following embodiments, a composite type thin film magnetic head 1 having a recording head, which records magnetic signals on a storage medium, e.g., hard disk, and a reproducing head, which reproduces magnetic signals by using a magnetoresistance effect, will be explained as an example of the thin film magnetic head produced by the method of the present invention. The composite type thin film magnetic head is processed to form into a slider, and the slider is floated over the hard disk, by rotating the hard disk, so as to record and reproduce magnetic signals.

Note that, the present invention is not limited to the composite type thin film magnetic head.

In the present embodiment, firstly raw bars 10, in each of which a plurality of thin film magnetic heads 1 are arranged in a line, are cut from a wafer before forming the independent thin film magnetic heads 1. Then, each of the raw bars 10 is pressed with a prescribed force and mechanically abraded, by a lapping apparatus, until reaching a predetermined size.

In the raw bar 10, a plurality of combinations of the thin film magnetic head 1, which includes the reproducing head and the recording head, and an electric lap guide (ELG) element 14, which is adjacent to the thin film magnetic head 1, are continuously formed. The constitution of the raw bar 10 is shown in FIG. 1, wherein an upper part shows an overall view and a lower part shows a partial enlarged view. A symbol “ABS” stands for an air bearing surface, which has been mechanically abraded.

Dozens of the thin film magnetic heads 1 are formed in the raw bar 10, and high accuracy is required for each of the thin film magnetic heads 1. Thus, the ELG element 14 for monitoring the abrasion progress is provided adjacent to each of the thin film magnetic heads 1 so as to control an amount of abrading each of the thin film magnetic heads 1. Therefore, the abrasion accuracy can be increased.

FIG. 2 is a sectional view of the ELG element 14 taken along the line A-A′ shown in FIG. 1. FIG. 3 is a sectional view of the ELG element 14 taken along the line a-a′ shown in FIG. 1. A symbol 25 stands for a nonmagnetic substrate composed of, for example, ALTIC, and a symbol 26 stands for a substrate protection film, which is formed on the nonmagnetic substrate 25 and composed of, for example, alumina. A lower shielding layer 27 composed of sendust is formed on the substrate protection film 26. An alumina layer 28, which constitutes a read-gap, is formed on the lower shielding layer 27. A known magnetoresistance effect element section (sensing section) 30 is formed on the alumina layer 28. In the present embodiment, a current in plane-GMR (CIP-GMR) element is used in the magnetoresistance effect element section (sensing section) 30.

Hard film layers 31 are composed of CoCrPt, used for magnetic domain control and respectively connected to ends of the magnetoresistance effect element section 30. Extended layers 32 are composed of, for example, copper and formed on the hard film layers 31. As shown in FIG. 3, columnar terminals 33 are respectively formed at ends of the extended layers 32.

An alumina layer 35, which constitutes the read-gap and a write-gap, is formed on the alumina layer 28 and the extended layers 32. An overcoat alumina layer 36, which acts as a protection layer, covers the alumina layer 35 and the columnar terminals 33. The overcoat alumina layer 36 is abraded until the columnar terminals 33 are exposed, and then monitoring pads 22a and 22b, which are composed of gold, are formed on the exposed upper faces of the columnar terminals 33.

On the other hand, in the thin film magnetic head 1, a symbol 16 stands for an element section. External connection pads 18a and 18b, which are used for reproducing signals, and external connection pads 20a and 20b, which are used for recording signals, are formed in the surface of the raw bar 10. The external connection pads 18a and 18b are connected to a magnetoresistance effect element section (sensing section), not shown, of the element section 16 via columnar terminals 38, which are composed of, for example, copper as well as the columnar terminals 33 of the ELG element 14 and which are indicated by dotted lines in FIG. 1, inner extended layers 39 composed of, for example, copper and a hard film layer (not shown). In the present embodiment, a TMR element is used in the magnetoresistance effect element section (sensing section) of the element section 16.

The external connection pads 20a and 20b are connected to a thin film coil layer (not shown) of the element section 16 via columnar terminals 41, which are composed of, for example, copper as well as the columnar terminals 33 of the ELG element 14 and which are indicated by dotted lines in FIG. 1, and inner extended layers 42 composed of, for example, copper.

Another example of the raw bar 10 is shown in FIG. 9, wherein the ELG elements 14 are provided on the both sides of the thin film magnetic layer 1. With this structure, abrasion progress of the thin film magnetic heads 1 can be monitored by the ELG elements 14, and number of the ELG elements 14 can be reduced.

Successively, the embodiment of the method of producing the thin film magnetic head 1 will be explained.

The raw bar 10 is adhered to a prescribed jig (not shown) and the air bearing surfaces ABS are mechanically abraded. In this process, the magnetoresistance effect element sections 30 of the ELG elements 14 and the magnetoresistance effect element sections of the thin film magnetic heads 1 are simultaneously abraded. The ELG elements 14 are connected to monitoring means (not shown) via the pads 22a and 22b, and resistance variations of the magnetoresistance effect element sections 30, which are caused by abrading the magnetoresistance effect element sections 30, are measured during the abrasion process.

In the mean time, the variation of the resistance ELG-R of the magnetoresistance effect element section 30 of the ELG element 14 and an amount of abrading the thin film magnetic head 1 (a height h of the thin film magnetic head 1) are correlated, so that the resistance ELG-R of the ELG element 14 can be converted into an element height MR-h of the magnetoresistance effect element section of the thin film magnetic head 1 by monitoring the resistance ELG-R.

When the element height MR-h of the magnetoresistance effect element section of the thin film magnetic head 1 reaches a prescribed value, the mechanical abrasion is stopped.

Note that, even if the mechanical abrasion is completed, existence or nonexistence of a smear in the air bearing surface ABS cannot be known at that time.

Conventionally, the raw bar is ion-etched for a predetermined time period, and an amount of etching is the greatest necessary amount for removing all of smears from the entire raw bar. However, the entire raw bar is evenly etched, so the PTR in the air bearing surface ABS of the non-smeared thin film magnetic head 1 must be too deep.

Thus, in the present embodiment, the resistance ELG-R of the magnetoresistance effect element section 30 of the ELG element 14 and the resistance MR-R of the magnetoresistance effect element section of the thin film magnetic head 1 are measured after completing the mechanical abrasion, and then the existence or nonexistence of a smear in the air bearing surface ABS of the thin film magnetic head 1 is detected on the basis of the difference between the resistance ELG-R and the resistance MR-R.

Next, a concrete example of detecting the existence or nonexistence of a smear will be explained.

A smear does not substantially influence the resistance ELG-R because the magnetoresistance effect element section 30 of the ELG element 14 has a CIP structure. On the other hand, in case that a TMR element 2 (see FIG. 10) or an element having a CPP structure is used in the magnetoresistance effect element section of the thin film magnetic head 1, a smear extremely influences the resistance MR-R, which is the resistance in the direction perpendicular to an element surface

Namely, as shown FIG. 10, if the smear exists in the magnetoresistance effect element section (the TMR element 2) of the thin film magnetic head 1, the resistance of the element is reduced by short circuit, and the element height MR-h introduced by a theoretical formula is higher than the element height ELG-h converted from the resistance ELG-R. By using this principle, the existence of a smear can be detected when the difference “(MR-h)−(ELG-h)” is a positive value.

Even if the thin film magnetic head 1 and the ELG element 14 are adjacently arranged, but they cannot be perfectly overlapped. Even if the difference is a positive value, a smear does not always exist due to displacement of the thin film magnetic head 1 and the ELG element 14. To solve this problem, experiments are performed with a plurality of samples so as to define a threshold value. Namely, if the difference “(MR-h)−(ELG-h)” is a positive value and greater than the threshold value, the existence of a smear is detected. In the present embodiment, the threshold value is +0.03 μm (see FIG. 4).

By employing the above described detection manner, the smeared thin film magnetic head or heads 1 in the raw bar 10 can be detected (see FIG. 5). Therefore, a step of removing smears can be performed for only the smeared thin film magnetic head or heads 1.

A first example of the step of removing a smear is shown in FIG. 6. A buffing pad 61 is moved to the thin film magnetic head 1 of the raw bar 10, which has been judged as the smeared thin film magnetic head, along a rail 62. Then, the pad 61 is reciprocally moved within a smeared range indicated by an arrow.

A second example of the step of removing a smear is shown in FIG. 7. The thin film magnetic heads 1 in the raw bar 10 other than the smeared thin film magnetic head 1 are covered with a metal mask 64, and then a smeared range 65 is etched by ion beams.

A third example of the step of removing a smear is shown in FIG. 8. The thin film magnetic heads 1 in the raw bar 10 other than the smeared thin film magnetic head 1 are covered with a protection layer 64 composed of resist, and then a smeared range 67 is wet-etched.

The smeared places and size and number of the smears can be known from the difference “(MR-h)−(ELG-h)”. Therefore, the suitable manner of removing a smear can be selected from the first to third examples on the basis of conditions of smears.

Only the smeared place or places can be processed by the suitable smear removing manner, so secondary adverse influences, e.g., forming further smears in the smear removing step, can be restrained.

After performing the step of removing the smear, the entire surface of the raw bar 10, which includes the air bearing surfaces of the thin film magnetic heads 1, is etched by ion beams.

This step is the final step for removing foreign matters including smears from the air bearing surfaces. As described above, in the conventional method, the amount of etching is the greatest necessary amount for removing all of smears from the entire raw bar, so the PTRs in the air bearing surfaces must be too deep. On the other hand, in the present embodiment, the smeared places are detected and smears are removed therefrom, so the time of the ion beam etching can be highly shortened and the problem of deepening the PTRs can be solved.

After abrading the raw bar 10, the ELG elements 14 are cut and separated from the thin film magnetic heads 1, so that the independent thin film magnetic heads 1 can be produced.

Note that, in another embodiment, firstly the smeared thin film magnetic heads 1 are detected, and then the thin film magnetic heads 1 are cut from the raw bar 10 to form the independent thin film magnetic heads 1. In this case, smears are removed from the independent smeared thin film magnetic heads 1.

As described above, in the method of the present invention, the smeared thin film magnetic heads in the raw bar, which has been mechanically abraded, can be detected, and the smear removing step can be performed for only the smeared thin film magnetic heads.

Namely, the problem of short circuit caused by smears can be solved, the time of the ion beam etching, which is performed in the final step of removing foreign matters from the air bearing surfaces, can be shortened, and the problem of deepening the PTRs can be solved.

Therefore, the air bearing surfaces of the thin film magnetic heads can be finished with high accuracy, so that the thin film magnetic heads having excellent reproducing characteristics can be produced.

Note that, in the above described embodiments, the TMR element is used in the magnetoresistance effect element section of the thin film magnetic head, and the GMR element is used in the magnetoresistance effect element section of the ELG element, but the present invention is not limited to the above described embodiments.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A method of producing a thin film magnetic head from a raw bar, in which a plurality of combinations of a thin film magnetic head including a reproducing head and an ELG element are continuously formed, said method comprising the steps of:
measuring resistance of a magnetoresistance effect element section of each ELG element as first resistance;
measuring resistance of a magnetoresistance effect element section of each thin film magnetic head as second resistance;
detecting existence or nonexistence of a smear in an air bearing surface of each thin film magnetic head on the basis of the difference between the first resistance and the second resistance; and
removing the smear from only the thin film magnetic head in which the existence of the smear is detected.

2. The method according to claim 1,
wherein said removing step is performed by abrading only the thin film magnetic head, in which the existence of the smear is detected, with an abrasion pad.

3. The method according to claim 1,
wherein said removing step is performed by etching only the thin film magnetic head, in which the existence of the smear is detected, with ion beams.

4. The method according to claim 1,
wherein said removing step is performed by wet-etching only the thin film magnetic head, in which the existence of the smear is detected.

5. The method according to claim 1,
further comprising the step of etching the entire surface of the raw bar, which includes the air bearing surfaces of the thin film magnetic heads, with ion beams after performing said removing step.

6. The method according to claim 2,
further comprising the step of etching the entire surface of the raw bar, which includes the air bearing surfaces of the thin film magnetic heads, with ion beams after performing said removing step.

7. The method according to claim 3,
further comprising the step of etching the entire surface of the raw bar, which includes the air bearing surfaces of the thin film magnetic heads, with ion beams after performing said removing step.

8. The method according to claim 4,
further comprising the step of etching the entire surface of the raw bar, which includes the air bearing surfaces of the thin film magnetic heads, with ion beams after performing said removing step.
